(19) United States
(12) Patent Application Publication
(10) Pub. No.: US 2007/0182067 A1
(43) Pub. Date: Aug. 9, 2007

(54) Method for molding a sound canal of a hearing device

(76) Inventors: Werner Fickweiler, Bubenreuth (DE); Harald Klemenz, Furth (DE); Marco Lederer, Hirschaid/Erlach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/652,260

(22) Filed: Jan. 11, 2007

(30) Foreign Application Priority Data
Jan. 13, 2006 (DE) 10 2006 001 847.8

(51) Int. Cl. B29C 33/40

(52) U.S. Cl. 264/401; 264/219; 264/222

(57) ABSTRACT

The aim is to manufacture molded tubes for hearing instruments and other hearing devices more cost-effectively. To this end, there is provision for producing a bending mold with the aid of a rapid-prototyping method. An unmolded tube is inserted into the bending mold. Heat is then applied to the bending mold, including the inserted tube, such that after cooling the tube permanently assumes the shape predetermined by the bending mold. Rapid prototyping makes it possible to produce a bending mold for a variety of tube forms quickly and cost-effectively. It is thus no longer necessary to bend the tubes manually, as a result of which the degree of automation can ultimately be increased.

### CROSS REFERENCE TO RELATED APPLICATIONS

This application claims priority of German application No. 10 2006 001 847.8 filed Jan. 13, 2006, which is incorporated by reference herein in its entirety.

### FIELD OF THE INVENTION

The present invention relates to a method for molding a sound canal of a hearing device and in particular of a hearing instrument.

### BACKGROUND OF THE INVENTION

In behind-the-ear (BTE) hearing instruments, sound has to be guided by the hearing instrument with the aid of a piece of tube to the auditory canal. At the auditory-canal end, the piece of tube is in many cases held by an earmold. The piece of tube consequently serves as a sound canal that transports the sound amplified by the hearing instrument to the auditory canal.

For cosmetic reasons, it is advantageous if the sound tube is guided as closely as possible to the auricula. It must therefore be matched as well as possible to the external contour of the auricula. A problem here is that the sound tubes have to have a variety of shapes for different wearers of hearing instruments. Thus with children, for example, apart from the contours, substantially shorter sound tubes have to be used than with adults.

The shape of the sound tube consequently depends not only on the individual contour of the ear of the wearer of the hearing instrument, but also on the shape of the hearing instrument itself and on the type of earmold. Even the diameter of the piece of tube varies from application to application. Furthermore, the prefabricated tubes in many cases already have the necessary adapter pieces for connecting to the hearing instrument and to the earmold. In this case, it is necessary to bring the adapter pieces on the tube ends to the required spatial position and orientation.

Sound tubes which have to have a very specific shape are also generally provided in in-the-ear hearing instruments. This shape depends substantially on the hearing-instrument shell which is in turn individually adapted to the wearer of the hearing instrument.

Due to the numerous different shapes of sound canals in and on hearing instruments, these have until now mainly been produced manually. For this purpose, the sound tubes are as a rule deformed in a hot-air blower. Alternatively, so-called “nail boards” are also used in which the tubes are fixed with nails or pins and then heated in a furnace. After cooling, they then have the required shape. However, this manual production is very labor-intensive and gives rise to correspondingly high costs.

From the prior printed publication DE 39 39 352 A1 a device is known for bending small-bore pipe sections made of thermoplastic plastics. Here, the pipe sections are inserted at normal temperature into a bending mold and braced. Heat is then fed in. After cooling, the pipe section is taken out of the bending mold.

Also, from prior printed publications DE 42 15 920 A1 and DE 696 13 130 T2, methods are known for bending plastic pipes in which heating and cooling and suitable molds are used.

### SUMMARY OF THE INVENTION

The object of the present invention is consequently to organize the molding of sound canals or sound tubes so as to be more time- and cost-effective.

This object is achieved according to the invention in a method for molding a sound canal of a hearing device, in particular of a hearing instrument, by producing a bending mold for the sound canal with the aid of a rapid-prototyping method, inserting an unmolded tube into the bending mold and applying heat to the bending mold including the inserted tube, such that after cooling the tube permanently assumes the shape predetermined for the sound canal by the bending mold.

In an advantageous manner, it is thus possible to manufacture bending molds for hearing devices and in particular for hearing instruments very quickly, so that it is also worthwhile producing bending molds for numerous different tube shapes. In addition, the degree of automation in the manufacture of sound tubes can be increased by means of such bending molds.

To produce the bending mold, a 3D model that describes a geometric shape of a sound canal is preferably provided, having at least one optional parameter and being parameterized in a suitable manner. With model-based shaping, the contour of a bending mold can be determined quickly and cost-effectively.

The at least one parameter of the 3D model can, for example, be the diameter or the length of the tube. In this way, not only the shape of the tube but also its dimensions can be individually adjusted.

The prototyping method or rapid-prototyping method may contain stereo lithography (STL), selective laser sintering (SLS), etc. Using these design methods, shapes can be produced which cannot be manufactured readily or at all using customary casting methods.

In a preferred embodiment of the inventive method, the tube for connecting a behind-the-ear hearing instrument to an earmold is fashioned. The tube may, however, also be fashioned for use as a tube section inside a hearing instrument. It is thus possible in both cases rapidly to create a bending mold that is suited to the individual anatomy of a wearer of a hearing instrument.

### BRIEF DESCRIPTION OF THE DRAWINGS

The present invention will now be explained in detail with the aid of the attached drawings, in which:

FIG. 1 shows in three-dimensional representation a bending mold produced by means of a rapid-prototyping method and a hearing-instrument tube to be bent and

FIG. 2 shows a three-dimensional view of the bending mold from FIG. 1, into which the hearing-instrument tube is inserted.

### DETAILED DESCRIPTION OF THE INVENTION

The exemplary embodiment described in greater detail below represents a preferred embodiment of the present invention.

The invention is based upon the idea of producing a bending mold which is on the one hand quick to produce and on the other can be altered rapidly. To this end, the rapid-prototyping method for manufacturing plastic molds is used. The bending mold needed can thus be produced in a short time by altering a given parameter and in this way adjusted to new requirements. The basis here is a three-dimensional model in which freely selectable parameters are created in order to change for example radii, lengths, etc. If the required shape, including the corresponding parameters, is found, an STL model is derived therefrom. To do this, an STL (Standard Transformation Language) interface is used, which is a standard interface of many CAD systems. This data interface, which is also called a stereo-lithography interface, primarily serves to provide geometric information from three-dimensional data models for production by means of generative production methods or rapid-prototyping systems. This enables the closed description of the surface of 3D bodies with the aid of triangular facets. Each triangular facet is characterized by the triangle points and the associated surface normals of the triangle. These overall geometric values are needed in defined form for further data processing in the construction process.

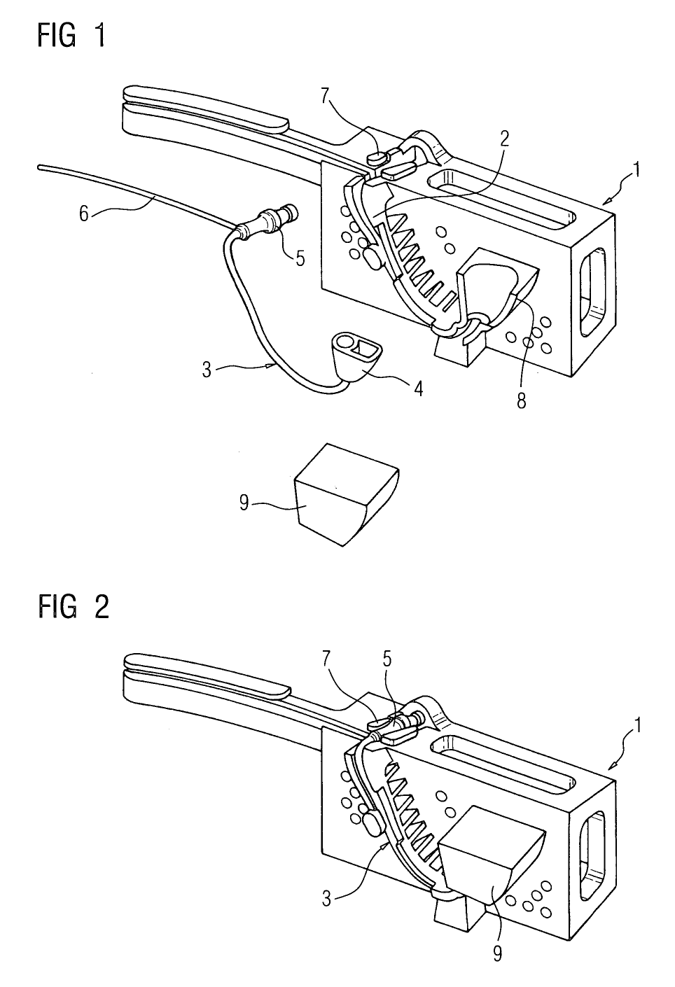

The STL data is now fed for example to a stereo-lithographic method and a bending mold 1 is produced as reproduced three-dimensionally in FIG. 1. The bending mold 1 has a segment 2 into which a tube 3 to be bent has to be inserted. The tube 3 has at one end a hearing-instrument adapter 4, by means of which it is connected to a hearing instrument. There is located at the other end of the tube 3 an earmold adapter 5 which is placed into a corresponding earmold. Also attached to this adapter 5 is a flexible elongated retaining piece 6 which is inserted into a recess of the auricula of the wearer of the hearing instrument in order to fix the tube and the earmold.

The bending mold 1 has a first adapter holder 7 into which the earmold adapter 5 can be locked. In addition, there is also provided on the bending mold 1 a second adapter receiver 8, into which the hearing-instrument adapter 4 can be inserted. A retaining element 9 is attached to the second adapter receiver 8 in order to retain the hearing-instrument adapter 4 inside the adapter receiver 8. By virtue of the two adapter receivers 7 and 8, the precise spatial position and orientation of the two tube adapters 4 and 5 relative to one another is fixed. The segment 2 determines the path of the tube between the two adapters 4, 5.

FIG. 2 shows the status at which the tube 3 is inserted into the bending mold 1 and fixed. At this status, heat is applied to the tube, e.g. in a furnace, for thermal deformation. After cooling, the tube 3 retains the predetermined shape and can be used for the individual hearing instrument.

The application of heat to the tube 3 clamped into the bending mold 1 can also be achieved through microwave radiation, infrared radiation and other radiation variants. Of course, the possibility exists of heating the bending mold with the tube by means of a hot-air blower, as mentioned in the introduction.

If a new tube is to be manufactured, then, taking as a starting point an existing tube shape for which a three-dimensional model is available, a new bending mold can be produced through appropriate reparameterizing. This simplified manufacture of the bending molds is also worthwhile when bending only a few tubes. In addition, the rapid-prototyping method makes it possible for bending molds to be duplicated very cost-effectively. Here, the computer-aided production method results in high reproduction precision for the duplicates.

1.-6. (canceled)

7. A method for molding a sound canal of a hearing device, comprising:
creating a bending mold for the sound canal by a rapid-prototyping method;
inserting a tube into the bending mold;
applying heat to the bending mold comprising the inserted tube; and
cooling the tube so that the tube is permanently molded to a predetermined shape for the sound canal by the bending mold.

8. The method as claimed in claim 7, wherein the bending mold is created based on a 3D model that defines a geometric shape of the sound canal.

9. The method as claimed in claim 8, wherein the 3D model comprises a parameter.

10. The method as claimed in claim 9, wherein a contour of the bending mold is determined by adjusting the parameter.

11. The method as claimed in claim 9, wherein the parameter is a diameter or a length of the tube.

12. The method as claimed in claim 7, wherein the rapid-prototyping method is a stereo-lithographic method.

13. The method as claimed in claim 7, wherein the tube connects a behind-the-ear hearing instrument to an earmold.

14. The method as claimed in claim 7, wherein the tube is within a hearing instrument.

15. A device for molding a sound canal of a hearing device, comprising:
a bending mold that has a predetermined shape of the sound canal;
a tube that is inserted into the bending mold;
a heating device that heats the bending mold comprising the inserted tube; and
a cooling device that cools the tube so that the tube is permanently molded to the predetermined shape of the sound canal by the bending mold.

16. The device as claimed in claim 15, wherein the bending mold is manufactured by a rapid-prototyping method.

17. The device as claimed in claim 16, wherein the rapid-prototyping method is a stereo-lithographic method.

18. The device as claimed in claim 15, wherein the bending mold is manufactured based on a 3D model that defines a geometric shape of the sound canal.

19. The device as claimed in claim 18, wherein the 3D model comprises a parameter.

20. The device as claimed in claim 19, wherein a contour of the bending mold is determined by adjusting the parameter.

21. The device as claimed in claim 19, wherein the parameter is a diameter or a length of the tube.

22. The device as claimed in claim 15, wherein the tube connects a behind-the-ear hearing instrument to an earmold.

23. The device as claimed in claim 15, wherein the tube is within a hearing instrument.

24. The device as claimed in claim 15, wherein the heating device is selected from the group consisting of: a furnace, a microwave radiation device, an infrared radiation device, and a hot air blower.
